(19) United States
(12) Patent Application Publication
(10) Pub. No.: US 2012/0049093 A1
(43) Pub. Date: Mar. 1, 2012

(54) RADIATION SHIELDING DEVICES

(75) Inventor: Alexandru Costea, Cincinnati, OH (US)

(73) Assignee: UNIVERSITY OF CINCINNATI, Cincinnati, OH (US)

(21) Appl. No.: 12/868,041

(22) Filed: Aug. 25, 2010

(51) Int. Cl. G21F 3/00

(52) U.S. Cl. 250/515.1

(57) ABSTRACT

A radiation shielding device comprises a first leaded shield assembly comprising a lower portion and an upper portion, wherein: at least the upper portion comprises a transparent leaded material; the first leaded shield assembly is operable to prevent further transmission of at least some radiation generated by a fluoroscopy device; the first leaded shield assembly comprises an outer vertical edge and an inner vertical edge; the inner vertical edge of the first leaded shield assembly further comprises a notch positioned between the upper portion and the lower portion, the notch defining a table edge and a patient edge; and the first leaded shield assembly is configured such that the table edge may be positioned under a patient supporting table and the patient edge may be positioned above a patient laying on the patient supporting table.

### TECHNICAL FIELD

The present disclosure generally relates to radiation shielding devices, in particular, to radiation shields for medical procedures using a fluoroscopy imaging.

### BACKGROUND

As background, fluoroscopy imaging is used by medical professionals to obtain real-time images of the internal structures of a patient during medical procedures. This may be done, for example, during electrophysiology procedures. During the electrophysiology procedure, the fluoroscopy imaging allows the medical professionals to manipulate safely the mapping catheters within the patient's heart while monitoring potential structural abnormalities or complications.

Fluoroscopy images are based on emission of X-rays or other types of radiation in order to obtain the real-time images of the internal structures of the body. During the medical procedure, these X-rays and other radiation may pose a health risk to the patient and to the medical professionals performing the procedure. In order to minimize this harmful effect, medical professionals are required to wear protective lead aprons and jackets. Therefore, they are particularly susceptible to increased health risks due to radiation exposure as well as searing heavy protective gear since they may participate in multiple medical procedures daily.

Existing radiation shields include, for example, lead aprons intended to be worn by the medical professional, as well as other types of shields which interfere with the movement of the medical professional. Also, because the lead aprons are heavy, they may cause back, knee, and foot wear and tear injuries for the medical professional. Consequently, there is a need for radiation shielding devices which reduce or eliminate the exposure of medical professionals to the radiation produced by the fluoroscopy device while still allowing the medical professionals to move freely around the patient and potentially without having to wear lead protective gear.

### SUMMARY

In one embodiment, a radiation shielding device includes a first leaded shield assembly having a lower portion and an upper portion. At least the upper portion includes a transparent leaded material. The first leaded shield assembly is operable to prevent further transmission of at least some radiation generated by a fluoroscopy device. The first leaded shield assembly has an outer vertical edge and an inner vertical edge, wherein the inner vertical edge of the first leaded shield assembly includes a notch positioned between the upper portion and the lower portion, the notch defining a table edge and a patient edge. The first leaded shield assembly is configured such that the table edge may be positioned under a patient supporting table and the patient edge may be positioned above a patient laying on the patient supporting table.

In another embodiment, a radiation shielding device includes a first leaded shield assembly and a second leaded shield assembly. The first and second leaded shield assemblies are configured to engage one another to define a patient-accepting opening through which a patient supporting table and a patient positioned on the patient supporting table may extend. The first and second leaded shield assemblies are operable to prevent transmission of at least some radiation propagating below and above a plane defined by the patient supporting table when the first and second leaded shield assemblies are in an engagement position. At least an upper portion of the first and second leaded shield assemblies includes a transparent material.

In yet another embodiment, a radiation shielding device includes a first leaded shield assembly and a second leaded shield assembly. The first and second leaded shield assemblies each have a lower portion, an upper portion, an outer vertical edge, and an inner vertical edge. At least the upper portion includes a transparent leaded material. The first and second leaded shield assemblies are operable to prevent further transmission of at least some radiation generated by a fluoroscopy device. The inner vertical edge of the first and second leaded shield assemblies include a notch positioned between the upper portion and the lower portion, the notch defining a table edge and a patient edge. The first and second leaded shield assemblies are configured such that the table edge is positionable under a patient supporting table and the patient edge is positionable above a patient laying on the patient supporting table when the inner vertical edge of the first leaded shield assembly is engaged with the inner vertical edge of the second leaded shield assembly. The first and second leaded shield assemblies further include a lead curtain coupled to the patient edge that is operable to shield a gap between the patient edge of the first leaded shield assembly and the patient from radiation transmission.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference characters and in which:

FIG. 1 depicts a radiation shielding device according to one or more embodiments shown and described herein;

FIG. 2 depicts an end view of a radiation shielding device according to one or more embodiments shown and described herein;

FIG. 3 depicts a side view of a radiation shielding device according to one or more embodiments shown and described herein;

FIG. 4 depicts an end view of a radiation shielding device according to one or more embodiments shown and described herein;

FIG. 5 depicts a side view of a radiation shielding device according to one or more embodiments shown and described herein;

FIG. 6 depicts a top view of a radiation shielding device according to one or more embodiments shown and described herein;

FIG. 7 depicts an end view of a radiation shielding device and curtain according to one or more embodiments shown and described herein; and

FIGS. 8A-C depict a top view of a radiation shielding device according to one or more embodiments shown and described herein.

### DETAILED DESCRIPTION

The embodiments described herein generally relate to radiation shielding devices which protect medical professionals from radiation produced by a fluoroscopy device. The fluoroscopy device may be used to facilitate tests or medical procedures performed on the patient by permitting a medical professional to obtain real-time moving images of the internal structures of the patient. Such real-time images may assist the medical professional in performing the test or procedure. For example, during electrophysiological procedures on a patient's heart, the fluoroscopy device allows the medical professional to visualize the location and orientation of catheters placed inside the heart. Such procedures can be very complex and time consuming, and they may expose the patient and the medical professional to a relatively high level of radiation (e.g., emitted by the fluoroscopy device).

Although the patient is exposed to radiation during the medical procedure or test, this may not pose a significant health issue since the number of exposures is limited. The medical professional and associated staff, however, can be potentially exposed to relatively high levels of radiation from the fluoroscopy device since they may perform multiple procedures on different patients on a daily basis. Thus, radiation shielding devices are needed which reduce or eliminate the exposure of medical professionals to the radiation produced by the fluoroscopy device while still allowing the medical professionals to move freely around the patient.

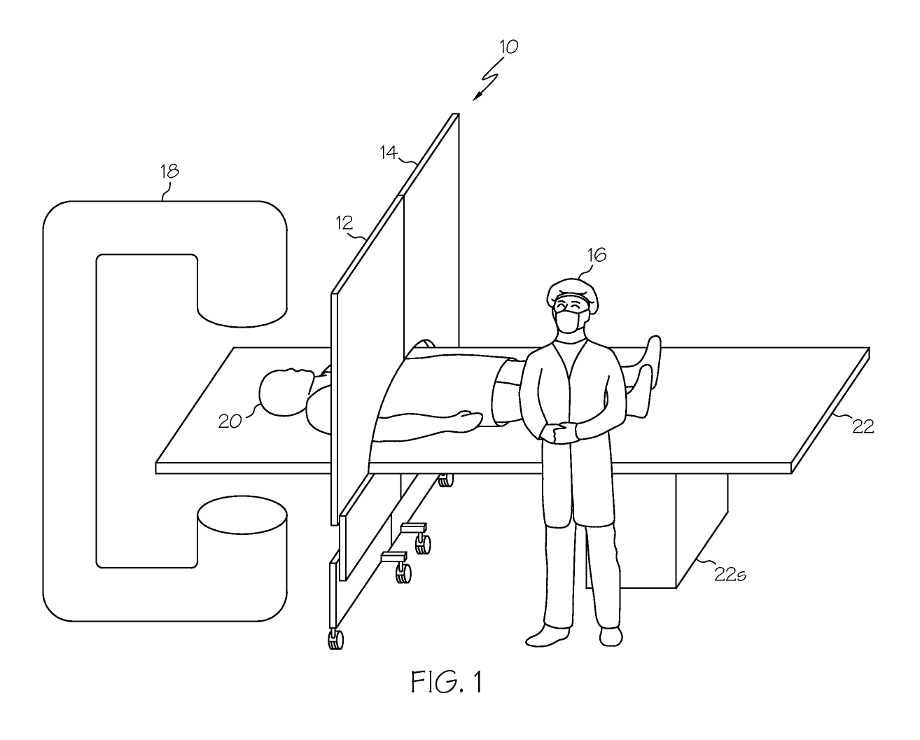

FIG. 1 depicts one embodiment of a radiation shielding device 10 which comprises a first leaded shield assembly 12 and a second leaded shield assembly 14. The radiation shielding device 10 may be used to shield a medical professional 16 from some or all of the radiation generated by a fluoroscopy device 18. The medical professional 16 may be administering a medical procedure or test to a patient 20 lying on a supporting table 22. The fluoroscopy device 18 may generate radiation during the medical test or procedure, and the radiation may be directed toward the part of the patient's body which is undergoing the test or procedure. The radiation shielding device 10 may be installed around the patient 20 and the supporting table 22 such that the radiation shielding device 10 prevents transmission of at least some of the radiation generated by the fluoroscopy device 18, thus reducing or eliminating the exposure of the medical professional 16 to such radiation. As a benefit, the portion of the patient's body disposed on the protected side of the radiation shielding device 10 may also be shielded from some or all of the radiation.

During the medical procedure, the patient 20 may be lying flat on the supporting table 22. The support 22s for the supporting table 22 may be disposed proximate to the patient's feet, as shown in FIG. 1. This arrangement frees the area beneath the supporting table 22 which supports the patient's legs, hips, torso, and head and allows this area to remain open. This may allow the supporting table 22 to be moved freely both cranially and caudally in order to position the X-ray camera of the fluoroscopy device 18 appropriately. This may also allow the X-ray camera to move freely beneath the patient's torso in order to, for example, obtain different views of the heart. The radiation from the fluoroscopy device 18 may be emitted from the tube disposed beneath the supporting table 22 and received by the tube disposed above the patient 20. Although most of the radiation may be directed toward and received by the tube disposed above the patient 20, some radiation may still be directed toward the medical professional 16 due to, for example, the scattering of X-rays coming from beneath the supporting table 22, striking the patient's back, and being transmitted through the patient's chest.

The radiation shielding device 10 may be installed around the patient 20 and the supporting table 22, as shown in FIG. 1, in order to prevent some or all of the radiation generated by the fluoroscopy device 18 from reaching the medical professional 16. As such, the first leaded shield assembly 12 and the second leaded shield assembly 14 may be disposed on opposite sides of the supporting table 22. Before performing the test or procedure, the two leaded shield assemblies 12, 14 may be pulled away from the supporting table 22 to allow the patient 20 to lie down on the supporting table 22. After the patient 20 lies down on the table supporting table 22, the two leaded shield assemblies 12, 14 may be adjusted to fit around the patient 20 and the supporting table 22. The adjustment may allow the gap between the radiation shielding device 10 and the supporting table 22 to be minimized and also may allow the gap between the radiation shielding device 10 and the patient 20 to be minimized. The two leaded shield assemblies 12, 14 may then be pushed together so that they join at approximately the middle of the supporting table 22. The fluoroscopy device 18 may then be operated while the medical professional stands on the protected side of the radiation shielding device 10 (as shown in FIG. 1). The construction and operation of the radiation shielding device 10 will now be described in detail.

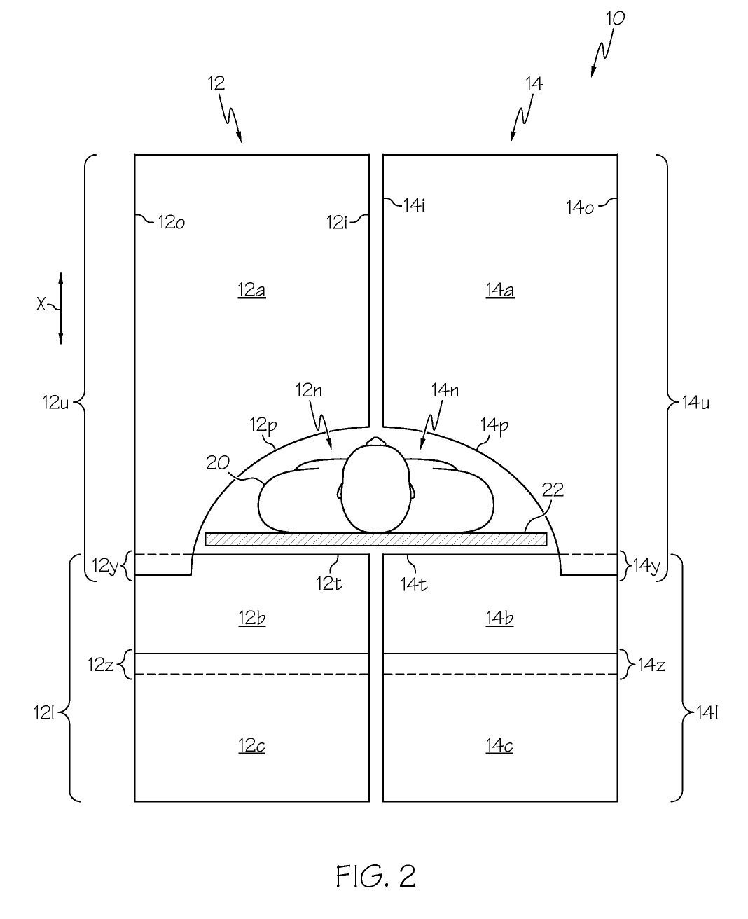

Referring to FIG. 2, an end view of a radiation shielding device 10 according to one embodiment is shown. As discussed herein, the radiation shielding device 10 comprises a first leaded shield assembly 12 and a second leaded shield assembly 14. The first and second leaded shield assemblies may be symmetrical in configuration, as shown, or they may be asymmetrical in configuration. The second leaded shield assembly 14 comprises components which correspond to those of the first leaded shield assembly 12. Thus, for purposes of this disclosure, only the components of the first leaded shield assembly 12 are described. It is noted that the descriptions, features, and characteristics of the components of the first leaded shield assembly 12 are applicable to the corresponding components of the second leaded shield assembly 14.

The first leaded shield assembly 12 may comprise an upper portion 12u and a lower portion 12l. The upper portion 12u may comprise a transparent leaded material which is capable of preventing further transmission of at least some radiation generated by the fluoroscopy device. The transparency of the upper portion 12u may allow the medical professional to view the portion of the patient 20 which lies on the fluoroscopy side of the first leaded shield assembly 12. This may permit the medical professional and the patient 20 to communicate more easily with each other and may permit the medical professional to observe any actions or facial expressions of the patient 20. In this manner, the upper portion 12u may protect the medical professional from some or all of the radiation to which he would have otherwise been exposed without the radiation shielding device 10. The transparent leaded material may comprise the element lead or a suitable lead-based compound which is known to be effective in radiation shielding. For example, the leaded material may comprise lead glass, which may include standard glass containing up to about 30% lead oxide (PbO) by weight. Other types of transparent leaded material may be used as well.

The lower portion 12l of the first leaded shield assembly 12 may comprise a transparent leaded material or an opaque leaded material, either of which is capable of preventing further transmission of at least some radiation generated by the fluoroscopy device. If the lower portion 12l comprises transparent leaded material, it may comprise lead glass or similar materials, as previously described herein. If the lower portion 12l comprises opaque leaded material, it may comprise lead or any suitable compound of lead. As an example, opaque leaded material may include a base material (e.g., plastic or wood) covered with a suitable layer of lead or lead oxide. Because the lower portion 12l is beneath the supporting table 22, and because it is uncommon for the medical professional to need to view this area, the lower portion 12l typically comprises an opaque leaded material. Thus, in one embodiment, the upper portion 12u comprises a transparent leaded material, and the lower portion 12l comprises an opaque leaded material.

The first leaded shield assembly 12 may comprise an outer vertical edge 12o and an inner vertical edge 12i. The inner vertical edge 12i may comprise a notch 12n disposed between the upper portion 12u and the lower portion 12l. The notch 12n may define a table edge 12t and a patent edge 12p that further defines a patient-accepting opening. The first leaded shield assembly 12 may be configured so that a table edge 12t is positioned under the supporting table 22, and a patient edge 12p is positioned above a patient 20 lying on the supporting table 22. The patient edge 12p may have an arcuate shape such as, for example, an elliptical shape which may facilitate the positioning of the patient edge 12p over patients of varying size. The patient edge 12p may have other suitable shapes as well including, but not limited to, combinations of two or more geometric shapes.

The upper portion 12u may be adjustable such that its height may be varied to accommodate patients of different sizes. That is, the upper portion 12u may be capable of being moved along the X-axis, as depicted in FIG. 2, so that the patient edge 12p conforms for the most part to the shape of the patient 20. Likewise, the lower portion 12l may be capable of being moved along the X-axis so that the table edge 12t may be adjusted to accommodate supporting tables of different heights. These adjustments allow the radiation shielding device 10 to be adjusted to reduce the gaps that may occur between the radiation shielding device 10 and both the patient 20 and supporting table 22.

In one embodiment, the upper portion 12u may comprise a first sheet of leaded material 12a. As described herein, the first sheet of leaded material 12a may comprise a transparent leaded material (e.g., glass containing a suitable amount of lead oxide). The lower portion 12l may comprise a second sheet of leaded material 12b and a third sheet of leaded material 12c, each of which may be transparent or opaque. The first sheet of leaded material 12a may be capable of being moved along the X-axis, as depicted in FIG. 2, so that the patient edge 12p conforms to the shape of the patient 20. Likewise, the second sheet of leaded material 12b may be capable of being moved along the X-axis so that the table edge 12t may be adjusted to accommodate the height of the supporting table 22. These adjustments allow the radiation shielding device 10 to be adjusted to accommodate supporting tables of varying heights and patients of varying sizes. The third sheet of leaded material 12c may be fixed so that it is not adjustable along the X-axis. These adjustments may allow the device to accommodate different heights of the supporting table 22 which, in turn, accommodate heights of the medical professional. Thus, it may be advantageous for the radiation shielding device 10 to be able to be adjustable to accommodate different heights of the supporting table 22 as well as different sizes of the patient 20.

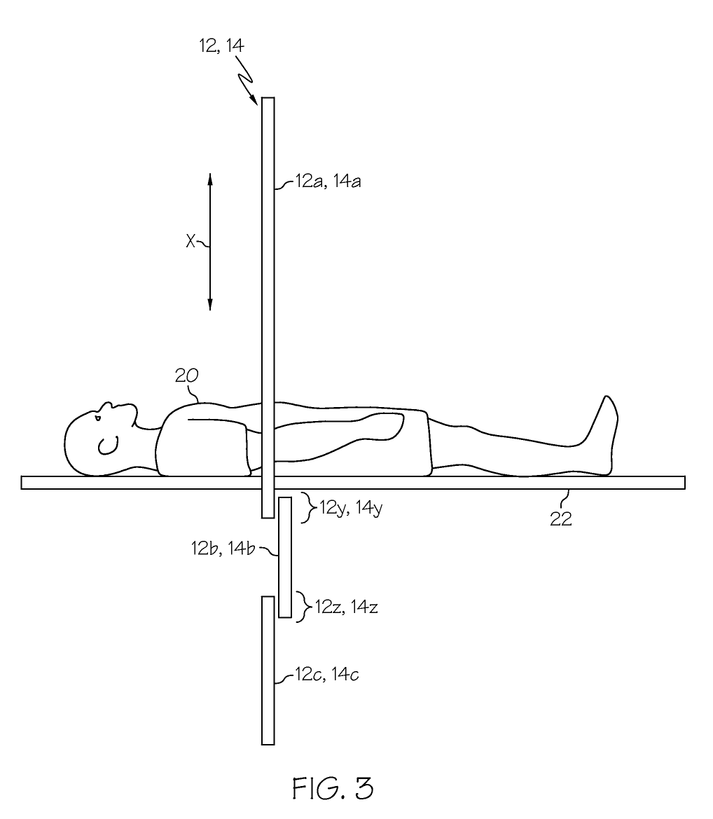

Referring to FIGS. 2 and 3, the radiation shielding device 10 may further have an upper overlap region 12y and a lower overlap region 12z. These overlapping regions may permit the first sheet of leaded material 12a and the second sheet of leaded material 12b to be adjusted along the X-axis while still preventing further transmission of at least some radiation generated by the fluoroscopy device. The upper overlap region 12y may be disposed between the first sheet of leaded material 12a and the second sheet of leaded material 12b. Likewise, the lower overlap region 12z may be disposed between the second sheet of leaded material 12b and the third sheet of leaded material 12c. The vertical dimension (i.e., X-axis dimension) of the first, second, and third sheets of leaded material 12a, 12b, 12c may be designed such that there is always some overlap in the upper overlap region 12y and in the lower overlap region 12z over the entire adjustable range of the first and second sheets of leaded material 12a, 12b. Although the first sheet 12a and third sheet 12c are shown as overlapping on the same side of the second sheet 12b, it is contemplated that the upper overlap region 12y and the lower overlap region 12z may be on either side.

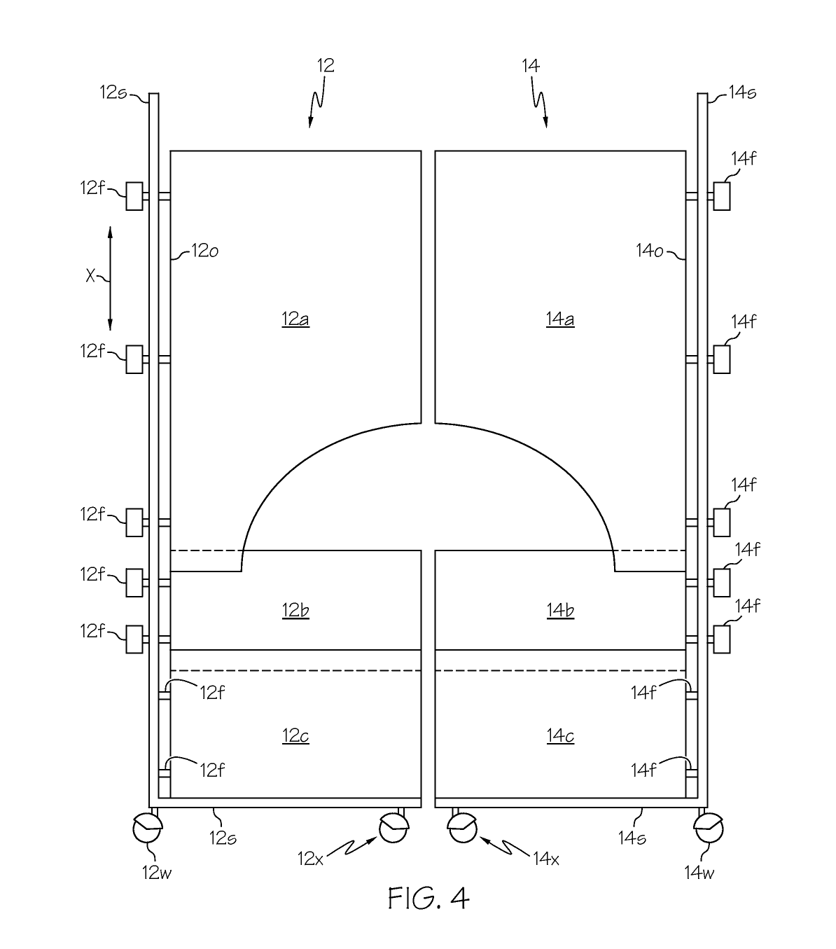

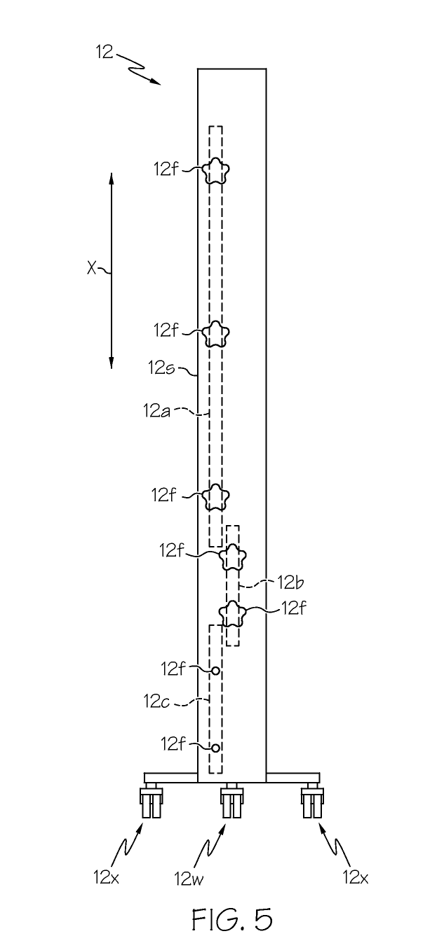

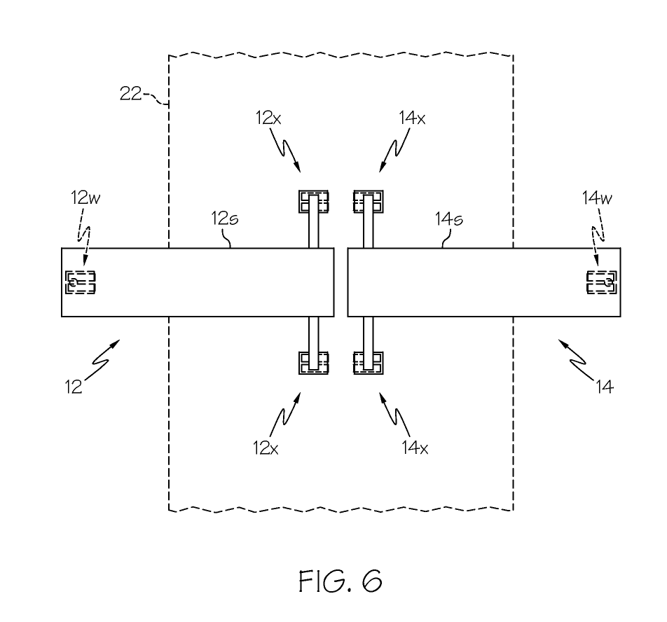

FIGS. 4-6 depict a support structure 12s of the radiation shielding device. The first leaded shield assembly 12 may comprise a support structure 12s which is capable of supporting the first, second and third sheets of leaded material 12a, 12b, 12c. The support structure 12s may have an “L” shape or any other suitable geometry. The first, second and third sheets of leaded material 12a, 12b, 12c may be mechanically coupled to the support structure 12s through a plurality of brackets 12f. The brackets 12f support the weight of the sheets, and two or more brackets 12f may be used for each sheet. The brackets 12f for the first and second sheets of leaded material 12a, 12b may comprise knobs which may allow the bracket 12f to be manually loosened or tightened. These brackets 12f may also be inserted in slots (not shown) in the support structure 12s such that they slide in the slots and thereby permit the first and second sheets of leaded material 12a, 12b to be manually adjusted along the X-axis. The brackets 12f for the third sheet of leaded material 12c may omit the knob since this sheet is typically not adjustable. Thus, the user may loosen the appropriate brackets 12f, adjust the first or second sheets of leaded material 12a, 12b to a suitable height, and re-tighten the brackets 12f. In this manner, the first or second sheets of leaded material 12a, 12b may be easily adjusted along the X-axis by the user.

As discussed herein, the support structure 12s may have an “L” shape and may include a vertical member (e.g., to which the brackets 12f are coupled) and a horizontal member (e.g., near the bottom of the third sheet of leaded material 12c). In this embodiment, the weight of the first and second sheets of leaded material 12a, 12b may be transferred to the vertical member of the support structure 12s via the corresponding brackets 12f. As an alternative, the horizontal member may be omitted, such that the support structure 12s only includes the vertical member. In this embodiment, the weight of the first and second sheets of leaded material 12a, 12b may be transferred to the third sheet of leaded material 12c via the brackets 12f coupling the third sheet of leaded material 12c to the support structure 12s. Other suitable configurations of the support structure 12s are contemplated as well.

The support structure 12s may comprise an outer wheel assembly 12w and an inner wheel assembly 12x. The outer wheel assembly 12w may comprise a single caster (e.g., a pair of wheels capable of swiveling) and may be disposed near the outer edge of the leaded shield assemblies 12. The outer wheel assembly 12w may be disposed between the planes of the first sheet and the third sheet of leaded material, 12a, 12c. This disposition may allow the outer wheel 12w to receive a portion of the weight of the first leaded shield assembly.

The inner wheel assembly 12x may comprise two casters, each of which extends away from the leaded shield assemblies 12. The combination of the outer wheel assembly 12w and the inner wheel assembly allow the first leaded shield assembly 12 and second leaded shield assembly 14 to be manually pulled apart and pushed together. The casters may swivel to allow a user to easily move the leaded shield assemblies 12 along the floor in any direction. The extension of two casters of the inner wheel assemblies 12x away from the first leaded shield assembly 12 may provide stability, since the first leaded shield assembly 12 may be quite heavy (e.g., due to the lead content). The length of the extension may be about 15 inches on each side of the support structure 12s or may be any other suitable value. Also, because the extension of the two casters is disposed near the inside edge of the first leaded shield assemblies 12, the extended casters are disposed beneath the supporting table 22 and out of the way of the medical professional.

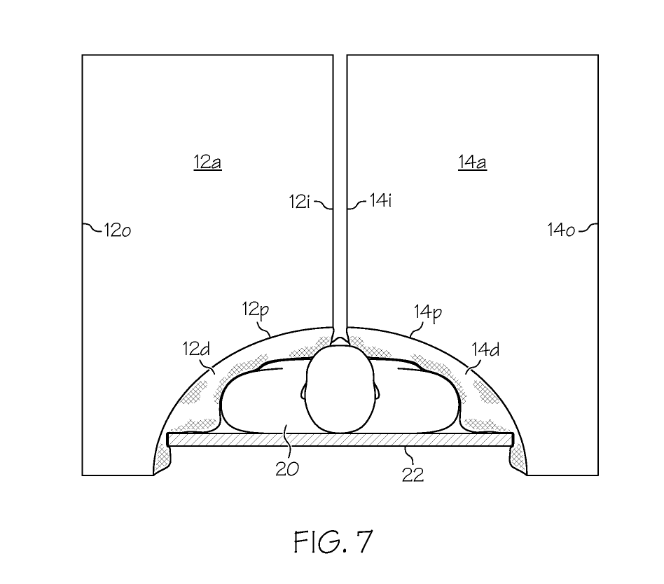

FIG. 7 shows one embodiment of the first sheet of leaded material 12a having a lead curtain 12d which reduces the gap between the patient 20 and the first sheet of leaded material 12a. The lead curtain 12d is disposed on the first sheet of leaded material 12a and may be coupled to the patient edge 12p of the first sheet of leaded material 12a. The lead curtain 12d may comprise a flexible material which is capable of conforming to the body of the patient 20 lying on the supporting table 22. For example, the lead curtain 12d may comprise strips of cloth material covered with a layer of lead or lead oxide. The cloth strips may overlap and hang down so as to contact the patient 20. It is contemplated that the lead curtain 12d may be constructed of other materials and have other suitable designs. The flexibility of the lead curtain 12d allows it to conform for the most part to the body of the patient 20, thus minimizing or eliminating any gaps between the first sheet of leaded material 12a and the patient 20. Accordingly, the lead curtain 12d may, at least in part, rest on the patient's body during the medical procedure. The reduction or elimination of this gap may prevent some or all of the radiation generated by the fluoroscopy device from reaching the medical professional disposed on the other side of the radiation shielding device.

The length of the lead curtain 12d may be between about 1 inch and about 5 inches and, in one embodiment, may be about 3 inches. The length of the lead curtain 12d does not have to be constant across the patient edge 12p and may, for example, become longer as it nears the edge of the supporting table 22 (e.g., to span the gap created where the patient's body meets the supporting table 22). The lead curtain 12d may be attached to the patient edge 12p through any number of techniques including, but not limited to, epoxy and fasteners (e.g., screws, tacks). The lead curtain 12d may be designed so that it can be replaced as needed.

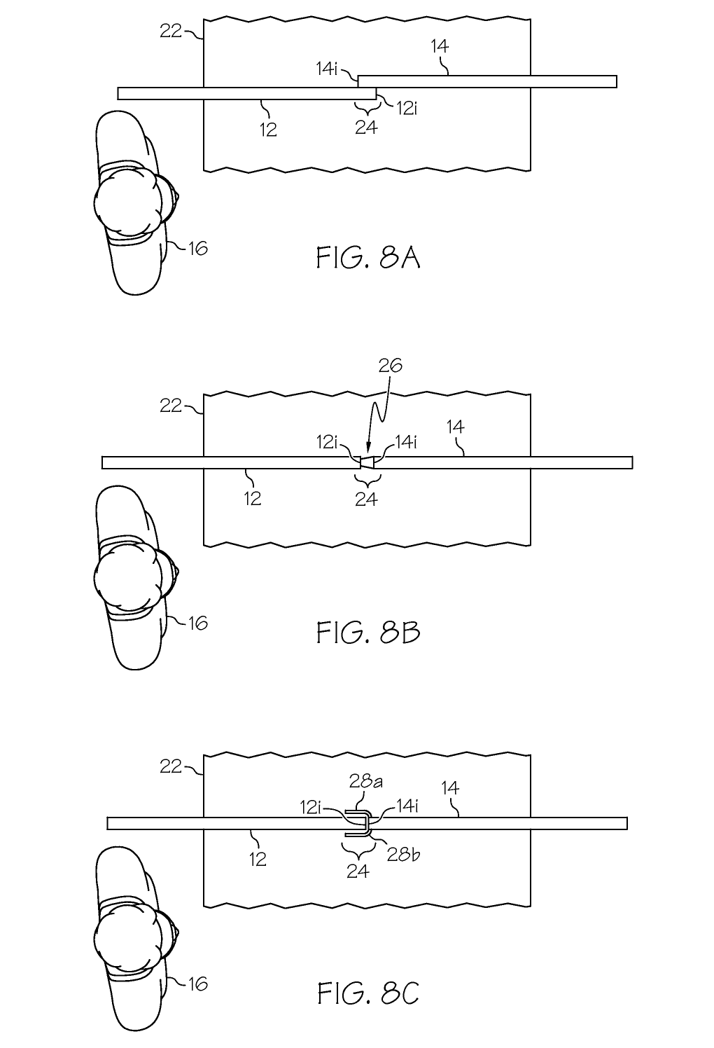

Referring to FIGS. 8A-C, three embodiments are shown of an engagement region 24 between the first leaded shield assembly 12 and the second leaded shield assembly 14. When the first leaded shield assembly 12 and second leaded shield assembly 14 are pushed together (as shown in FIG. 1), the inner vertical edge 12i, 14i of each assembly are engaged at one or more engagement regions. These engagement regions may allow the two assemblies to be joined together such that little or no radiation (from the fluoroscopy device) is able to pass through the engagement regions, thus protecting the medical professional 16 from exposure to the radiation. The engagement region 24 may be disposed between the first, second, and third sheets of leaded material (e.g., as shown in FIG. 2) for each leaded shield assembly.

A number of techniques may be used to join the two assemblies at the engagement region 24. FIG. 8A illustrates one embodiment of the engagement region 24 in which the first leaded shield assembly 12 and the second leaded shield assembly 14 overlap. The amount of overlap may be suitable so as to minimize or eliminate any gap between the assemblies through which radiation may pass. The overlap may be applied to the first, second, and third sheets of leaded material. The establishment of the overlap may be performed by manually adjusting the positions of the first and second leaded shield assemblies 12, 14 with respect to one another. The overlap may be oriented so that any radiation which passes through a gap in the overlap may pass in a direction away from the medical professional 16.

FIG. 8B illustrates another embodiment of the engagement region 24 in which a curtain 26 is attached to the second leaded shield assembly 14. The curtain 26 may extend from the inner vertical edge 14i of the second leaded shield assembly 14 and engage the inner vertical edge 12i of the first leaded shield assembly 12 so as to eliminate any gap between the assemblies through which radiation may pass. The curtain 26 may comprise the same material as the lead curtain (shown in FIG. 7 and describe herein), or it may comprise another suitable material. The curtain 26 may be flexible so that the gap between the first and second assemblies is closed, even if the width of the gap varies. The curtain 26 may be attached to the first, second, and third sheet of leaded material of the second leaded shield assembly 14.

FIG. 8C illustrates yet another embodiment of the engagement region 24 in which two brackets 28a, 28b are attached to the second leaded shield assembly 14. The brackets 28a, 28b may extend from the second leaded shield assembly 14 and wrap around both sides of the first leaded shield assembly 12 so as to eliminate any gap between the assemblies through which radiation may pass. The brackets 28a, 28b may comprise the same material as the second leaded shield assembly 14, or it may comprise another suitable material. The brackets 28a, 28b may be attached to the first, second, and third sheet of leaded material of the second leaded shield assembly 14. As an alternative, only one bracket (e.g., bracket 28a) may be used and the other bracket (e.g., bracket 28b) is omitted. It is contemplated that many other types of engagement techniques may be used.

The engagement region 24 may be transparent or opaque. Thus the embodiments of the engagement region 24 described herein may use components and techniques which are either transparent or opaque, depending on the location of the engagement region 24. For example, if the engagement region 24 is disposed between transparent sheets (e.g., the first sheet of leaded material of the first and second leaded shield assemblies as shown in FIG. 2), the bracket, curtain, or other components used for that engagement region 24 may also be transparent. Likewise, if the engagement region 24 is disposed between opaque sheets, the bracket, curtain, or other components used for that engagement region 24 may also be opaque.

Referring again to FIG. 1, the radiation shielding device 10 may also be covered with sterile drapes (not shown) which may, in one embodiment, have a rectangular shape. The sterile drapes may be disposed at the level of the supporting table 22 and may surround the entire radiation shielding device 10 at the level of the patient 20 and the supporting table 22. In this manner, the sterile drapes may facilitate the maintenance of sterility of the operating field of the patient 20.

The radiation shielding device 10 may be relatively inexpensive to manufacture and deliver to customers. Furthermore, the operation of the radiation shielding device 10 can be manual. That is, one may push the first and second leaded shield assemblies 12, 14 together in order to set up the radiation shield. Likewise, one can pull the assemblies apart in order to disengage the radiation shield. The shielding device, since it is relatively flat, may be easily stored away when it is not being used.

It should now be understood that the radiation shielding devices described herein may shield a medical professional from radiation generated by a fluoroscopy device. In one embodiment, a shielding device comprises a first and a second leaded shield assembly which can be disposed on opposite sides of the supporting table. The first and second assemblies may be pushed together when the patient is situated on the supporting table so as to form a single radiation shielding device which prevents transmission of some or all of the radiation generated by the fluoroscopy device. This may protect the medical professional and associated staff from being exposed to such radiation.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A radiation shielding device comprising a first leaded shield assembly comprising a lower portion and an upper portion, wherein:
at least the upper portion comprises a transparent leaded material;
the first leaded shield assembly is operable to prevent further transmission of at least some radiation generated by a fluoroscopy device;
the first leaded shield assembly comprises an outer vertical edge and an inner vertical edge;
the inner vertical edge of the first leaded shield assembly further comprises a notch positioned between the upper portion and the lower portion, the notch defining a table edge and a patient edge; and
the first leaded shield assembly is configured such that the table edge may be positioned under a patient supporting table and the patient edge may be positioned above a patient laying on the patient supporting table.

2. The radiation shielding device as claimed in claim 1, wherein the first leaded shield assembly is configured to be adjusted such that a height of the lower portion may be varied to accommodate different heights of the patient supporting table.

3. The radiation shielding device as claimed in claim 1, wherein the first leaded shield assembly is configured to a be adjusted such that a height of the upper portion may be varied to accommodate different sizes of the patient.

4. The radiation shielding device as claimed in claim 1, wherein:
the upper portion of the first leaded shield assembly comprises a first sheet of leaded material, and the lower portion of the first leaded shield assembly comprises a second sheet of leaded material and a third sheet of leaded material;
at least the first sheet of leaded material is transparent;
a lower section of the first sheet overlaps an upper section of the second sheet in an upper overlap region and is maintained in an overlapping relationship with a first adjustable clamp assembly; and
a lower section of the second sheet overlaps an upper section of the third sheet in a lower overlap region and is maintained in an overlapping relationship with a second adjustable clamp assembly.

5. The radiation shielding device as claimed in claim 4, wherein a height of first sheet of leaded material is configured to be adjusted by the first adjustable clamp assembly according to a size of the patient.

6. The radiation shielding device as claimed in claim 4, wherein a height of the second sheet of leaded material is configured to be adjusted by the second adjustable clamp assembly according to a height of the patient supporting table

7. The radiation shielding device as claimed in claim 4, wherein a first portion of the notch is defined by the first sheet of leaded material and a second portion of the notch is defined by the second sheet of leaded material.

8. The radiation shielding device as claimed in claim 4, wherein the second and third sheets of leaded material are transparent.

9. The radiation shielding device as claimed in claim 4, wherein the second and third sheets of leaded material are opaque.

10. The radiation shielding device as claimed in claim 1, wherein the first leaded shield assembly further comprises a lead curtain coupled to the patient edge that is configured to shield a gap between the patient edge of the first leaded shield assembly and the patient from radiation transmission.

11. The radiation shielding device as claimed in claim 1, wherein:
the first leaded shield assembly comprises a bottom edge extending between the inner and outer vertical edges; and
the first leaded shield assembly further comprises an outer wheel assembly coupled to the bottom edge and proximate the outer vertical edge and an inner wheel assembly coupled to the bottom edge and proximate the inner vertical edge.

12. The radiation shielding device as claimed in claim 1, wherein:
the radiation shielding device further comprises a second leaded shield assembly comprising an upper portion and a lower portion;
at least the upper portion of the second leaded shield assembly comprises a transparent leaded material;
the second leaded shield assembly is operable to prevent further transmission of at least some radiation generated by the fluoroscopy device;
the second leaded shield assembly comprises an outer vertical edge and an inner vertical edge;
the inner vertical edge of the second leaded shield assembly further comprises a notch positioned between the upper portion and the lower portion of the second leaded shield assembly, the notch defining a table edge and a patient edge;
the second leaded shield assembly is configured such that the table edge may be positioned under the patient supporting table and the patient edge may be positioned above the patient laying on the patient supporting table; and
the inner vertical edge of the second leaded shield assembly is configured to engage the inner vertical edge of the first leaded shield assembly at one or more engagement regions.

13. The radiation shielding device as claimed in claim 12, wherein the first and second leaded shield assemblies are symmetrical.

14. The radiation shielding device as claimed in claim 12, wherein one of the first and second leaded shield assemblies is larger than the other.

15. The radiation shielding device as claimed in claim 12, wherein the first and second leaded shield assemblies are configured such that the patient is positioned within the notches of the first and second leaded shield assemblies when the inner vertical edge of the second leaded shield assembly is in an engagement position with the inner vertical edge of the first leaded shield assembly.

16. The radiation shielding device as claimed in claim 12, wherein the first leaded shield assembly overlaps the second leaded shield assembly at the one or more engagement regions.

17. The radiation shielding device as claimed in claim 12, wherein the inner vertical edge of the first leaded shield assembly and the inner vertical edge of the second leaded shield assembly are maintained in an engagement position with an engagement clamp assembly.

18. A radiation shielding device comprising a first leaded shield assembly and a second leaded shield assembly, wherein:
the first and second leaded shield assemblies are configured to engage one another to define a patient-accepting opening through which a patient supporting table and a patient positioned on the patient supporting table may extend;
the first and second leaded shield assemblies are operable to prevent transmission of at least some radiation propagating below and above a plane defined by the patient supporting table when the first and second leaded shield assemblies are in an engagement position; and
at least an upper portion of the first and second leaded shield assemblies comprise a transparent material.

19. The radiation shielding device as claimed in claim 18, wherein first and second leaded shield assemblies are further configured such that a size of the patient-accepting opening is adjustable.

20. The radiation shielding device as claimed in claim 18, wherein the first and second leaded shield assemblies are further configured such that a vertical position of the patient-accepting opening is adjustable.

21. The radiation shielding device as claimed in claim 18, wherein:
the first leaded shield assembly comprises a first notch and the second leaded shield assembly comprises a second notch; and
the first and second notches define the patient-accepting opening when the first and second leaded shield assemblies are in the engagement position.

22. The radiation shielding device as claimed in claim 18, wherein:
each of the first and second leaded shield assemblies comprise a first sheet of leaded material, a second sheet of leaded material, and a third sheet of leaded material;
at least the first sheet of leaded material is transparent;
a lower section of the first sheet overlaps an upper section of the second sheet in an upper overlap region and is maintained in an overlapping relationship with a first adjustable clamp assembly; and
a lower section of the second sheet overlaps an upper section of the third sheet in a lower overlap region and is maintained in an overlapping relationship with a second adjustable clamp assembly.

23. A radiation shielding device comprising a first leaded shield assembly and a second leaded shield assembly, wherein:
the first and second leaded shield assemblies each comprise a lower portion, an upper portion, an outer vertical edge, and an inner vertical edge;
at least the upper portion comprises a transparent leaded material;
the first and second leaded shield assemblies are operable to prevent further transmission of at least some radiation generated by a fluoroscopy device;
the inner vertical edge of the first and second leaded shield assemblies further comprises a notch positioned between the upper portion and the lower portion, the notch defining a table edge and a patient edge;
the first and second leaded shield assemblies are configured such that the table edge is positionable under a patient supporting table and the patient edge is positionable above a patient laying on the patient supporting table when the inner vertical edge of the first leaded shield assembly is engaged with the inner vertical edge of the second leaded shield assembly; and
the first and second leaded shield assemblies further comprise a lead curtain coupled to the patient edge that is operable to shield a gap between the patient edge of the first leaded shield assembly and the patient from radiation transmission.
